(19) United States
(12) Patent Application Publication
(10) Pub. No.: US 2024/0248176 A1
(43) Pub. Date: Jul. 25, 2024

(54) Method and Device for Recognizing a Blockage of a Lidar System, and Vehicle

(71) Applicant: Daimler Truck AG, Leinfelden-Echterdingen (DE)

(72) Inventors: Sebastian KLEINSCHMIDT, Hannover (DE); Chrysa KHOURY, Fellbach (DE)

(21) Appl. No.: 18/561,585

(22) PCT Filed: May 24, 2022
(86) PCT No.: PCT/EP2022/064062

§ 371 Date: Nov. 16, 2023

(30) Foreign Application Priority Data
May 26, 2021 (DE) 10 2021 002 795.7

(51) Int. Cl. G01S 7/48; G01S 7/481; G01S 7/497; G01S 17/42; G01S 17/931

(52) U.S. Cl. CPC G01S 7/4808; G01S 7/4817; G01S 17/42; G01S 17/931; G01S 2007/4975

(57) ABSTRACT

A method for recognizing a blockage of a lidar system of a vehicle. The lidar system scans an environment with several laser receiver systems in a shared field of vision. An object point cloud is identified which is created by reflection of laser beams of the laser receiver systems on a surface of an object located in the shared field of vision. It is determined whether points of the identified object point cloud originate from the laser beams of all of the laser receiver systems of the lidar system and substantially have the same intensities. It is concluded that the lidar system is blocked if the points do not originate from the laser beams of all of the laser receiver systems, or if the points originate from the laser beams of all of the laser receiver systems, but do not substantially have the same intensities.

### BACKGROUND AND SUMMARY OF THE INVENTION

The invention relates to a method for recognizing a blockage of a lidar system.

The invention further relates to a device for recognizing a blockage of a lidar system.

The method additionally relates to a vehicle.

A method for in-operation calibration of a lidar of a vehicle is known from DE 10 2020 007 772 A1, having the following method steps:
scanning a vehicle environment several times by means of the lidar to generate point clouds;
tracking a position relative to the lidar of scan points comprised by the point clouds;
determining a movement direction of the scan points by evaluating a relative position shift of the scan points between the point clouds;
determining an intersection point of the movement directions of a defined selection of scan points to determine a current vanishing point;
comparing a position of the current vanishing point with a known position of a reference vanishing point; and
when a position deviation between the current vanishing point and the reference vanishing point is defined: shifting a reference coordinate system or a current coordinate system to superimpose the current vanishing point on the reference vanishing point.

A vehicle having a lidar and a computer is further described, wherein the computer is equipped to carry out the method.

The object of the invention is to specify a new kind of method and a new kind of device for recognizing a blockage of a lidar system and a new kind of vehicle.

In a method according to the invention for recognizing an in particular optical blockage of a lidar system, in particular of a lidar system of a vehicle, the lidar system scans an environment, in particular an environment of the vehicle, with several laser receiver systems in a shared field of vision. An object point cloud is identified, which is created by reflection of laser beams of the laser receiver systems on a surface of an object located in the shared field of vision. It is determined whether points of the identified object point cloud originate from the laser beams of all the laser receiver systems of the lidar system and substantially have the same intensities. In other words, it is determined whether points generated in each case by the laser beams of all of the laser receiver systems of the lidar system as a result of the reflection of the respective laser beam are part of the object point cloud and substantially have the same intensities. If it is determined that the points of the identified object point cloud do not originate from the laser beams of all of the laser receiver systems of the lidar system, or if it is determined that the points of the identified object point cloud originate from the laser beams of all of the laser receiver systems of the lidar system, but do not substantially have the same intensities, it is concluded that the lidar system is blocked, i.e., the blockage of the lidar system is then recognized.

A device according to the invention for recognizing an, in particular optical, blockage of a lidar system, in particular of a lidar system of a vehicle, which is in particular designed and equipped to carry out the method specified above for recognizing the blockage of the lidar system, in particular of the lidar system of a vehicle, wherein the lidar system has several laser receiver systems which are designed and equipped to scan an environment, in particular an environment of the vehicle, in a shared field of vision, is designed and equipped to identify an object point cloud, which is created by reflection of laser beams of the laser receiver systems on a surface of an object located in the shared field of vision to determine whether points of the identified object point cloud originate from the laser beams of all of the laser receiver systems of the lidar system, and substantially have the same intensities, and to conclude that the lidar system is blocked, i.e., to recognize a blockage of the lidar system, if it is determined that the points of the identified object point cloud do not originate from the laser beams of all of the laser receiver systems of the lidar system, or that the points of the identified object point cloud originate from the laser beams of all of the laser receiver systems of the lidar system, but do not substantially have the same intensities.

The lidar system to be checked by means of the method or the device with regard to a blockage which may be present is thus designed as such a lidar system having several laser receiver systems that have a shared field of vision. As already specified above, the lidar system scans the environment, in particular the environment of the vehicle, with several laser receiver systems in a shared field of vision. It thus scans the environment, in particular the environment of the vehicle, with several laser beams in the shared field of vision, wherein the respective laser beam is generated and emitted by the respective laser receiver system, and reflected radiation of the respective laser beam, in particular caused by the objects reflecting the laser beam, is received by receivers of the laser receiver system. The respective laser receiver system is thus a laser transceiver system. The shared field of vision is also described as an overlap region.

To enable the described scan in the shared field of vision, fields of vision of the individual laser receiver systems overlap at least partially, wherein an overlap region, in which the fields of vision of the individual laser receiver systems overlap, forms the shared field of vision. The lidar system comprises at least two or more than two such laser receiver systems. Such a lidar system is also described as a multi-eye lidar system.

In a possible embodiment of the method, the lidar system scans the environment, in particular the environment of the vehicle, with two laser receiver systems in the shared field of vision. An object point cloud is identified, which is created via reflection of the laser beams of the two laser receiver systems on the surface of the object located in the shared field of vision. It is determined whether the points of the identified object point cloud originate from the laser beams of both of the laser receiver systems of the lidar system and substantially have the same intensities. In other words, it is determined whether the object point cloud comprises both points generated by the laser beam of one laser receiver system of the lidar system via the reflection of the laser beam and points generated by the laser beam of the other laser receiver system of the lidar system via the reflection of the laser beam, and whether all of these points substantially have the same intensities. If it is determined that the points of the identified object point cloud do not originate from the laser beams of both of the laser receiver systems of the lidar system, i.e., only originate from the laser beam of one of the two laser receiver systems of the lidar system, or if it is determined that the points of the identified object point cloud originate from the laser beams of both of the laser receiver systems of the lidar system, but do not substantially have the same intensities, it is concluded that the lidar system is blocked, i.e., the blockage of the lidar system is then recognized.

In a possible embodiment of the device, the lidar system has two laser receiver systems, which are designed and equipped to scan the environment, in particular the environment of the vehicle, in the shared field of vision. The device is designed and equipped to identify the object point cloud, which is created by reflection of the laser beams of the two laser receiver systems on the surface of the object located in the shared field of vision to determine whether the points of the identified object point cloud originate from the laser beams of both laser receiver systems of the lidar system and substantially have the same intensities, and to conclude a blockage of the lidar system, i.e., to recognize the blockage of the lidar system, if it is determined that the points of the identified object point cloud do not originate from the laser beams of both laser receiver systems of the lidar system, i.e., originate only from the laser beam of one of the two laser receiver systems of the lidar system, or that the points of the identified object point cloud originate from the laser beams of both of the laser receiver systems of the lidar system, but do not substantially have the same intensities.

Scan trajectories of the two laser receiver systems for example respectively run in the shape of a zigzag pattern or in a meandering or wavy manner. In the shared field of vision, these two scan trajectories intermesh without intersecting with each other. In particular, a wave crest of one scan trajectory protrudes at least partially into a wave trough of the other scan trajectory in the shared field of vision. In particular, the scan trajectories run opposite to each other and are offset in relation to each other by half a wavelength.

In the method and/or by means of the device, the object point cloud is in particular identified such that it comprises only two turning points of a scan trajectory of one of the two laser receiver systems in the shared field of vision. In this manner, the object point cloud comprises at most only the points of this scan trajectory between these two turning points, including these two turning points, and the points of this scan trajectory in the shared field of vision between these two turning points, and a preceding and a following turning point which are located outside of the shared field of vision and, if they are present, the points of the other scan trajectory which are located between these two turning points in the shared field of vision.

For example, it can also be provided that the object point cloud is identified in the method and/or by means of the device such that it comprises only the two turning points of the scan trajectory of one of the two laser receiver systems and a portion between these two turning points in the shared field of vision. In this manner, the point cloud comprises at most the points of this scan trajectory between these two turning points, including the two turning points, in the shared field of vision and, if present, the points of the other scan trajectory which are located between these two turning points in the shared field of vision. Only a strictly limited region of the shared field of vision is thus used to determine whether the points of the object point cloud originate from the laser beams of both laser receiver systems of the lidar system and have substantially the same intensities. In this strictly limited region, it should be assumed that this entire region is located on the same geometry with the same reflectivity, such that the points of the object point cloud of this strictly limited region must all have substantially the same intensity. If this is not the case, or if the points of the laser beam of one of the two laser receiver systems are missing, a blockage can thus be concluded with a high degree of certainty.

At least in many cases, a blockage of lidar systems, for example of so-called multi-eye lidar systems and also of other lidar systems which have sensors with an overlapping recording region, i.e., field of vision, can thus be ruled out via the solution described, in particular via the check of the scan trajectories described. Only lidar systems, for example multi-eye lidar systems, which are not blocked can ensure the safe operation, for example, of automated, in particular highly automated or autonomous, vehicles. If it cannot be compensated for by other sensors, a blockage of a lidar system, i.e., of one of the laser receiver systems, must lead to a deactivation of all autonomous driving functions, and is thus relevant to safety.

If a present blockage of the lidar system is recognized by means of the described solution, it can for example be provided that systems and functions based on the lidar system are deactivated or only operated to a limited extent. As an alternative or in addition, the vehicle user can for example be informed about the recognized blockage of the lidar system, for example, via an appropriate optical, acoustic and/or haptic warning. The vehicle user can thus try to remove the blockage themselves. As an alternative or in addition, maintenance of the lidar system can for example be arranged, for example automatic booking of a maintenance appointment in a garage, or booking such a maintenance appointment can be suggested to the vehicle user via the vehicle, whereby they can for example be supported in this booking via the vehicle or the vehicle arranges for the booking to be carried out automatically.

The device is for example a component of the lidar system or the lidar system is a component of the device.

A vehicle according to the invention comprises such a device.

Advantageously, the vehicle comprises the lidar system described above, which has several, in particular two, laser receiver systems which are designed and equipped to scan the environment, in particular the environment of the vehicle, in the shared field of vision.

The wording “substantially the same intensities” used above should in particular be understood to mean that the intensities match each other within a pre-determined tolerance range, i.e., that potential deviations of the intensities lie within pre-determined tolerances. In other words, the points have substantially the same intensities if determined intensity deviations lie within these pre-determined tolerances. If this is the case, then the intensities of the points are deemed to be the same or at least substantially the same. If intensity deviations are determined which do not lie within these pre-determined tolerances, i.e., exceed these pre-determined tolerances, then the intensities of the points are not deemed to be the same, and also not as substantially the same.

Exemplary embodiments of the invention are explained in more detail in the following with reference to drawings.

### BRIEF DESCRIPTION OF THE DRAWINGS

FIG. 1 schematically shows a side view of a traffic situation with two vehicles;

FIG. 2 schematically shows a scan trajectory of a laser receiver system of a lidar system;

FIG. 3 schematically shows scan trajectories of two laser receiver systems of a multi-eye lidar system;

FIG. 4 schematically shows scan trajectories of two laser receiver systems of a multi-eye lidar system with a shared field of vision;

FIG. 5 schematically shows portions of the scan trajectories of both laser receiver systems of the multi-eye lidar system in the shared field of vision;

FIG. 6 schematically shows a portion of a scan trajectory of one of the two laser receiver systems of the multi-eye lidar system in the shared field of vision; and

FIG. 7 schematically shows a device for recognizing a blockage of a lidar system, in particular of a lidar system of a vehicle, in particular to carry out a method for recognizing the blockage of the lidar system, in particular of the lidar system of a vehicle.

### DETAILED DESCRIPTION OF THE DRAWINGS

Parts corresponding to one another are provided with the same reference numerals in all Figures.

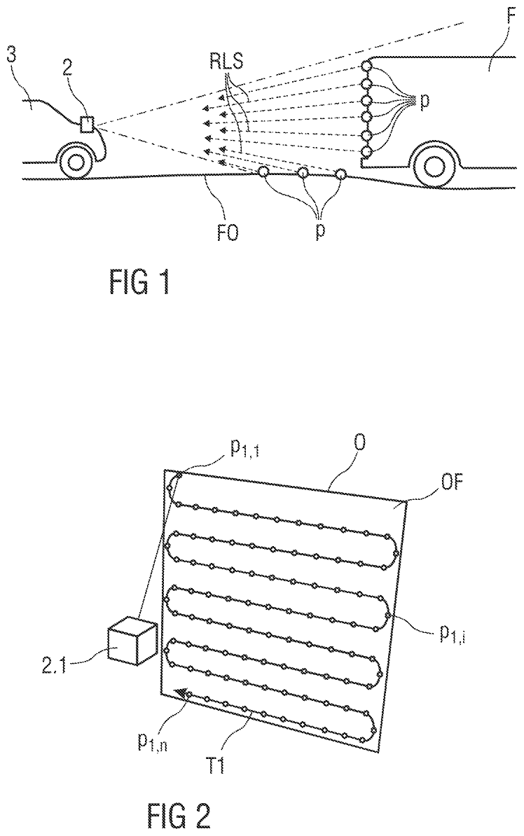

A method and a device 1 for recognizing a decalibration of a lidar system 2, in particular of a lidar system 2 of a vehicle 3, as well as a vehicle 3 are described in the following with reference to FIGS. 1 to 7, wherein the device 1 is advantageously designed and equipped to carry out the method and wherein the vehicle 3 advantageously comprises the device 1 and the lidar system 2. The method and the device 1 enable in particular an in particular optical blockage of the lidar system 2, in particular of a multi-eye lidar system, to be recognized.

Lidar or LiDAR is an abbreviation for “Light Detection And Ranging” and literally means “optical distance measurement”. Lidar is a similar measurement method to radar, which measures distance, location and intensity of an object O in the environment of, i.e., in an area surrounding the lidar system 2. For example, it uses ultra-violet radiation, infra-red radiation and radiation from the range of visible light. For this purpose, for example, light pulses can be used, and a distance to an object O can be calculated via a runtime measurement of the light. This measurement technique is called Amplitude Modulated (AM) LiDAR or Time of Flight (ToF) LiDAR.

To carry out a measurement with a ToF LiDAR sensor, i.e., a corresponding lidar system 2, one or more light pulses are emitted depending on the LiDAR model. The sensor receives the light pulses again after they are reflected on a present object O, and combines them in a LiDAR point cloud, described in the following as an object point cloud, as is schematically represented in exemplary form in FIG. 1 with reference to a side view of a traffic situation, with the vehicle 3 comprising the lidar system 2 and a further vehicle F. In this case, an object point cloud, i.e., a LiDAR point cloud, is a finite quantity of LiDAR points, described in the following as points p for short, which are described by a distance d, a location x, y, z and an intensity I.

As shown in FIG. 1, the light system 2, i.e., the lidar sensor, emits light pulses which are reflected on objects O which they hit, in the example depicted here on the further vehicle F and on a road surface FO. Laser beams RLS reflected by the respective object O are received by the lidar system 2, i.e., by the lidar sensor.

In recent years, the importance of lidar sensors, i.e., lidar systems 2, as a core modality for the realization of automated, in particular highly automated or autonomous, driving systems, i.e., vehicles 3, has increased. This is because lidar has clear advantages in relation to other 3D sensors. One advantage in relation to a stereo camera is, for example, that data quality from the generated lidar is largely uninfluenced by daylight and darkness.

A development of the lidar is the multi-eye LiDAR system, described in the following as a multi-eye lidar system. The solution described in the following for recognizing the blockage of the lidar system 2 relates to a lidar system 2 designed as such a multi-eye lidar system. In the multi-eye lidar system, several, i.e., at least two, laser receiver systems 2.1, 2.2, so-called “eyes”, are combined to form a lidar system 2. Scan trajectories T1, T2 of the eyes, i.e., of the laser receiver systems 2.1, 2.2, are variable, as the measurement method is based on oscillating reflection, unlike in the classic rotating LiDAR sensors.

FIG. 2 shows a schematic depiction of the scan trajectory T1 of such a laser receiver system 2.1 of the lidar system 2, here scanning a surface OF of an object O.

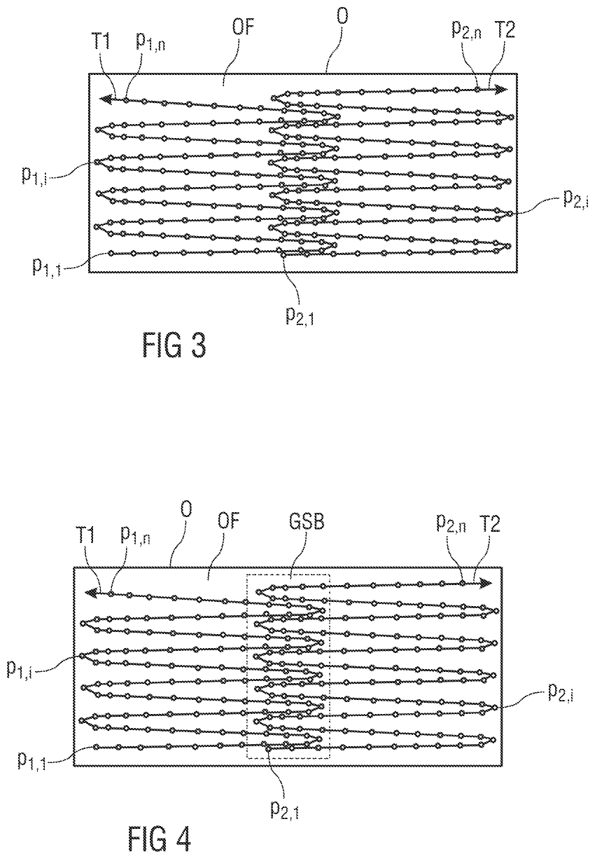

The scan trajectories T1, T2 of two or more eyes, i.e., laser receiver systems 2.1, 2.2, in a combined system, i.e., lidar system 2, are also described as a scan pattern. An example of a scan pattern of a lidar system 2 designed as a multi-eye lidar system having two laser receiver systems 2.1, 2.2, is schematically depicted in FIG. 3, here also scanning a surface OF of an object O.

To use such a lidar system 2 as a reliable core modality in an automated, in particular highly automated or autonomous, vehicle 3, it must be ensured that it functions correctly. If, for example, a housing of the lidar system 2 is dirtied or damaged, the respectively emitted beam of light, in particular laser beam, can be blocked, whereby a distance measurement is no longer possible. This can lead to incorrect interpretations with far-reaching consequences: If the reflected light, i.e., the reflected laser beam is not received again by the lidar system 2, i.e., by the respective laser receiver system 2.1, 2.2, then in proper condition, it is assumed that no body, i.e., no object O, has reflected the light, and thus the respective laser beam, and the distance covered by the light, i.e., by the respective laser beam, does not have an object O. Another cause, however, could for example be a blockage of one light source and/or of a receiver of the respective laser receiver system 2.1, 2.2, whereby potentially dangerous objects O would be overlooked, i.e., not detected by the lidar system 2.

The solution described in the following describes a technical method, which enables a blockage of the lidar system 2, in particular of the emitter, in particular laser emitter, and receiver of the laser receiver system 2.1, 2.2 without additional external sensors, and a device 1 for carrying out the method and a vehicle 3 having such a device 1. A technical method for recognizing a blockage of a lidar system 2 designed as a multi-eye lidar system 2 is described in the following. The described solution can additionally also be used for other lidar systems 2, which have a partially overlapping field of perception, i.e., a shared field of vision GSB, as shown in FIG. 4. In other words, in particular lidar systems 2 that have such an overlapping sensor region, i.e., such a shared field of vision GSB, which is in particular similar to the characteristics according to FIG. 4, can also be checked with regard to a blockage via the method described here.

The lidar system 2 to be checked by means of the method or the device 1 with regard to a potentially present decalibration, as already specified, is designed as a lidar system 2 having several, in the depicted example having two, laser receiver systems 2.1, 2.2, which have a shared field of vision GSB, also described as a multi-eye laser system.

The lidar system 2 scans the environment, in particular the environment of the vehicle 3, with several, in the depicted example with two, laser receiver systems 2.1, 2.2 in the shared field of vision GSB. It thus scans the environment, in particular the environment of the vehicle 3, with several, in the depicted example with two, laser beams in the shared field of vision GSB, wherein the respective laser beam is generated and emitted by the respective laser receiver system 2.1, 2.2, and reflected radiation of the respective laser beam, in particular caused by the objects O reflecting the laser beam, is received by the receiver of the laser receiver system 2.1, 2.2. The respective laser receiver system 2.1, 2.2 is thus a laser transceiver system.

To enable the described scan in the shared field of vision GSB, fields of vision of the individual laser receiver systems 2.1, 2.2 overlap at least partially, as shown in FIG. 4. Here, scan trajectories T1, T2 of two laser receiver systems 2.1, 2.2 of the lidar system 2 designed as a multi-eye lidar system with respective points p_{1,i} and p_{2,i} and with the shared field of vision GSB, i.e., the region in which the fields of vision and thus the scan trajectories T1, T2 of the laser receiver systems 2.1, 2.2 overlap, are schematically depicted. The index “1” denotes the association with the first scan trajectory T1 and the index “2” denotes the association with the second scan trajectory T2, and the index “i” is the running index (i=1 to n). The overlap region in which the fields of vision of the individual laser receiver systems 2.1, 2.2 overlap forms the shared field of vision GSB. As already mentioned, the lidar system 2 comprises at least two or more than two such laser receiver systems 2.1, 2.2. In the example depicted here, it comprises two such laser receiver systems 2.1, 2.2.

As described, the lidar system 2 thus scans the environment, in particular the environment of the vehicle 3, with several, in the depicted example with two, laser receiver systems 2.1, 2.2, and thus with several, here with two, laser beams, specifically with the laser beam of the respective laser receiver system 2.1, 2.2 in the shared field of vision GSB. To recognize a possible blockage, an object point cloud is identified, which is created via reflection of laser beams of the laser receiver systems 2.1, 2.2 on a surface OF of an object O located in the shared field of vision GSB. It is determined whether the points p_{1,i}, p_{2,i} of the identified object point cloud originate from the laser beams of all of the laser receiver systems 2.1, 2.2 of the lidar system 2 and thus, in the case described here, from the laser beams of both laser receiver systems 2.1, 2.2 of the lidar system 2, and substantially have the same intensities. In other words, it is determined whether points p_{1,i}, p_{2,i} generated in each case by the laser beams of all, in this example of both, of the laser receiver systems 2.1, 2.2 of the lidar system 2 as a result of the reflection of the respective laser beam are part of the object point cloud and substantially have the same intensities. If it is determined that the points p_{1,i}, p_{2,i} of the identified object point cloud do not originate from the laser beams of all, in the example depicted here of both, of the laser receiver systems 2.1, 2.2 of the lidar system 2, or if it is determined that the points p_{1,i}, p_{2,i} of the identified object point cloud originate from the laser beams of all, in the example depicted here of both, of the laser receiver systems 2.1, 2.2 of the lidar system 2, but do not substantially have the same intensities, it is concluded that the lidar system 2 is blocked, i.e., the blockage of the lidar system 2 is then recognized.

The scan trajectories T1, T2 of the two laser receiver systems 2.1, 2.2 for example respectively run in the shape of a zigzag pattern or in a meandering or wavy manner, as shown in FIGS. 2 to 6. In the shared field of vision GSB, these two scan trajectories T1, T2 intermesh without intersecting with each other. In particular, a wave crest of one scan trajectory T1, T2 protrudes at least partially into a wave trough of the other scan trajectory T2, T1 in the shared field of vision GSB. In particular, the scan trajectories T1, T2 run opposite to each other and are offset in relation to each other by half a wavelength.

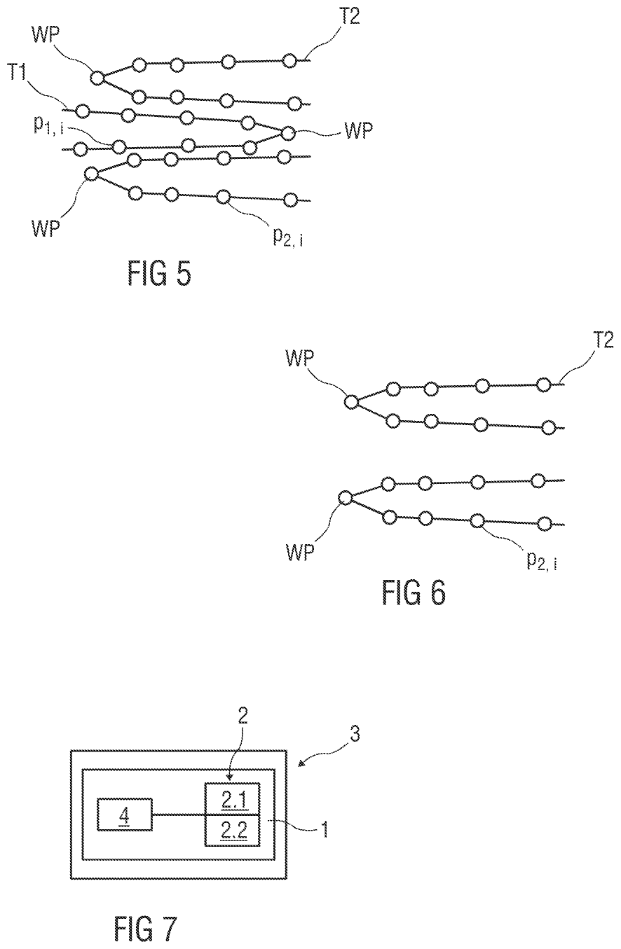

The object point cloud is in particular identified such that it comprises only two turning points WP of a scan trajectory T2, T1 of one of the two laser receiver systems 2.2, 2.1, in FIGS. 5 and 6 of the second scan trajectory T2 of the second laser receiver system 2.2, in the shared field of vision GSB, as shown in FIG. 5 and FIG. 6. In this manner, the object point cloud comprises at most only the points p_{2,i}, p_{1,i} of this scan trajectory T2, T1, here the points p_{2,i} of the second scan trajectory T2, between these two turning points WP, including these two turning points WP, and the points p_{2,i}, p_{1,i} of this scan trajectory T2, T1, here the points p_{2,i} of the second scan trajectory T2, in the shared field of vision GSB between these two turning points WP and a preceding and a following turning point WP located outside of the shared field of vision GSB (not depicted in FIGS. 5 and 6) and, if present, the points p_{1,i}, p_{2,i} of the other scan trajectory T1, T2, here the points p_{1,i} of the first scan trajectory T1, which are located between these two turning points WP in the shared field of vision GSB, as shown in FIG. 5. FIG. 6 shows the blockage of the lidar system 2, here of the first laser receiver system 2.1, such that the first scan trajectory T1 and its points_{1,i} are not present in the object point cloud.

For example, it can also be provided that the object point cloud is in particular identified such that it comprises only the two turning points WP of the scan trajectory T2, T1 of one of the two laser receiver systems 2.2, 2.1, in FIGS. 5 and 6 of the second scan trajectory T2 of the second laser receiver system 2.2, and a portion between these two turning points WP in the shared field of vision GSB. In this manner, the object point cloud comprises at most only the two points p_{2,i}, p_{1,i} of this scan trajectory T2, T1, here the points p_{2,i} of the second scan trajectory T2, between these two turning points WP, including these two turning points WP, in the shared field of vision GSB and, if present, the points p_{1,i}, p_{2,i} of the other scan trajectory T1, T2, here the points p_{1,i} of the first scan trajectory T1, which are located between these two turning points WP in the shared field of vision GSB. Only a strictly limited region of the shared field of vision GSB is thus used to determine whether the points p_{1,i}, p_{2,i} of the object point cloud originate from the laser beams of both laser receiver systems 2.1, 2.2 of the lidar system 2 and have substantially the same intensities.

For the shared field of vision GSB, i.e., the overlapping region of the two scan trajectories T1, T2, in which the two scan trajectories T1, T2 advantageously intermesh in the manner described above, the assumption can be made that the region between these turning points WP of one scan trajectory T2, T1, here the second scan trajectory T2, and the points p_{1,i}, p_{2,i} of the other scan trajectory T1, T2 located in between, here the intermediate points p_{1,i} of the first scan trajectory, in particular the turning point WP of the other scan trajectory T1, T2, here the first intermediate scan trajectory T1, are located on the same geometry with the same reflectivity. If no depth measurements can be performed repeatedly for the intermediate points p_{1,i}, p_{2,i} of the other scan trajectory T1, T2, here for the intermediate points p_{1,i} of the first scan trajectory T1, i.e., if these points p_{1,i}, p_{2,i} of the other scan trajectory T1, T2, here the points p_{1,i} of the first scan trajectory T1, are missing or if they have a differing intensity, it should be assumed that this laser receiver system 2.1, 2.2, and thus the first laser receiver system 2.1, i.e., its laser emitter and/or receiver, is blocked. The same approach can correspondingly also be inverted to recognize the blockage of the other laser receiver system 2.2, 2.1, here the second laser receiver system 2.2.

The phrase “substantially the same intensities” used above should in particular be understood to mean that the intensities match each other within a pre-determined tolerance range, i.e., that potential deviations of the intensities lie within pre-determined tolerances. In other words, the points p_{1,i}, p_{2,i} have substantially the same intensities if determined intensity deviations lie within these pre-determined tolerances. If this is the case, then the intensities of the points p_{1,i}, p_{2,i} are deemed to be the same or at least substantially the same. If intensity deviations are determined which do not lie within these pre-determined tolerances, i.e., exceed these pre-determined tolerances, then the intensities of the points p_{1,i}, p_{2,i} are not deemed to be the same, and also not substantially the same.

FIG. 7 shows the vehicle 3 with an exemplary schematic depiction of the device 1 for recognizing the blockage of the lidar system 2, in particular of the lidar system 2 of the vehicle 3, in particular to carry out the described method for recognizing the blockage of the lidar system 2, in particular of the lidar system 2 of the vehicle 3.

In the example depicted, the device 1 comprises the lidar system 2 having the several, in the depicted example two, laser receiver systems 2.1, 2.2. In other examples, the lidar system 2 can for example be a component of the vehicle 3, but not of the device 1, wherein the device 1 is then also a component of the vehicle 3. In other examples, the device 1 can be a component of the lidar system 2, which is advantageously a component of the vehicle 3.

The device 1 advantageously comprises a processing unit 4, in particular for carrying out and evaluating at least one or several of the method steps described above, in particular all of the method steps described above.

The processing unit 4 can for example be a component of the lidar system 2, i.e., a processing unit 4 which is already present can for example also be used to carry out the method described here for recognizing the blockage of the lidar system 2, in particular of the lidar system 2 of the vehicle 3. The method described here for recognizing the blockage of the lidar system 2 can thus for example be implemented in the lidar system 2.

1.-10. (canceled)

11. A method for recognizing a blockage of a lidar system (2) of a vehicle (3), comprising the steps of:
scanning an environment by the lidar system (2) with a plurality of laser receiver systems (2.1, 2.2) in a shared field of vision (GSB);
identifying an object point cloud which is created by reflection of respective laser beams of the plurality of laser receiver systems (2.1, 2.2) on a surface (OF) of an object (O) located in the shared field of vision (GSB);
determining whether points (p_{1,i}, p_{2,i}) of the identified object point cloud originate from the respective laser beams of all of the plurality of laser receiver systems (2.1, 2.2) and substantially have a same intensity; and
concluding that the lidar system (2) is blocked when the points (p_{1,i}, p_{2,i}) do not originate from the respective laser beams of all of the plurality of laser receiver systems (2.1, 2.2) or when the points (p_{1,i}, p_{2,i}) originate from the respective laser beams of all of the plurality of laser receiver systems (2.1, 2.2) but do not substantially have the same intensity.

12. The method according to claim 11, wherein the environment is an environment of the vehicle (3).

13. The method according to claim 11, wherein the plurality of laser receiver systems (2.1, 2.2) are two laser receiver systems (2.1, 2.2).

14. The method according to claim 13, wherein a respective scan trajectory (T1, T2) of the two laser receiver systems (2.1, 2.2) runs in a shape of a zigzag pattern or in a meandering or wavy manner and wherein the respective scan trajectories (T1, T2) intermesh in the shared field of vision (GSB) without intersecting each other.

15. The method according to claim 14, wherein the object point cloud is identified such that it comprises only two turning points (WP) in the shared field of vision (GSB) of the scan trajectory (T1, T2) of one of the two laser receiver systems (2.1, 2.2).

16. The method according to claim 15, wherein the object point cloud is identified such that it comprises only the two turning points (WP) and a portion between the two turning points (WP).

17. An apparatus for recognizing a blockage of a lidar system (2) of a vehicle (3), wherein the lidar system (2) has a plurality of laser receiver systems (2.1, 2.2) which are configured to scan an environment in a shared field of vision (GSB), comprising:
a device (1) that is configured to:
identify an object point cloud which is created by reflection of respective laser beams of the plurality of laser receiver systems (2.1, 2.2) on a surface (OF) of an object (O) located in the shared field of vision (GSB);
determine whether points (p_{1,i}, p_{2,i}) of the identified object point cloud originate from the respective laser beams of all of the plurality laser receiver systems (2.1, 2.2) and substantially have a same intensity; and
conclude that the lidar system (2) is blocked when the points (p_{1,i}, p_{2,i}) do not originate from the respective laser beams of all of the plurality of laser receiver systems (2.1, 2.2) or when the points (p_{1,i}, p_{2,i}) originate from the respective laser beams of all of the plurality of laser receiver systems (2.1, 2.2) but do not substantially have the same intensity

18. The apparatus according to claim 17, wherein the plurality of laser receiver systems (2.1, 2.2) are two laser receiver systems (2.1, 2.2).

19. A vehicle (3), comprising:
the apparatus according to claim 17.

20. The vehicle (3) according to claim 19, further comprising a lidar system (2), wherein the lidar system (2) has a plurality of laser receiver systems (2.1, 2.2) which are configured to scan an environment in a shared field of vision (GSB).
